(19) United States
(12) Patent Application Publication
(10) Pub. No.: US 2009/0128438 A1
(43) Pub. Date: May 21, 2009

(54) BALANCED AND SHORTENED ANTENNAS

(76) Inventor: Hyman D. Chantz, Scarsdale, NY (US)

Correspondence Address: SCHMEISER, OLSEN & WATTS, 22 CENTURY HILL DRIVE, SUITE 302, LATHAM, NY, 12110, US

(21) Appl. No.: 11/940,391

(22) Filed: Nov. 15, 2007

(51) Int. Cl. H01Q 1/36; H01Q 9/16

(52) U.S. Cl. 343/793; 343/895

(57) ABSTRACT

An antenna for radiating and/or receiving signals. The antenna includes (i) a first hollow and helical pipe, (ii) a second hollow and helical pipe, (iii) a first transmission wire, (iv) a second transmission wire, and (v) a dielectric connector. The dielectric connector physically couples to the first hollow and helical pipe and the second hollow and helical pipe. The first hollow and helical pipe and the second hollow and helical pipe comprise an electrically conductive material. The first transmission wire comprises a first portion and a second portion. The second transmission wire comprises a third portion and a fourth portion. The first portion of the first transmission wire and the third portion of the second transmission wire are inside the first hollow and helical pipe.

### FIELD OF THE INVENTION

The present invention relates generally to antennas, and more particularly to shortened antennas which are substantially balanced in their emission and reception fields.

### BACKGROUND OF THE INVENTION

A typical antenna is used to generate signals to the surrounding space and/or receive signals from the surrounding space. There is often a need to make the antenna physically shortened, and with as balanced or symmetrical a radio-frequency field as possible. When end-fed (FIG. 1) this balancing efficiency improves coupling to the free-space environment, and reduces non-wanted coupling into local conductive or dielectric objects. When center fed (FIG. 2) there is the additional advantage of reduced coupling from interfering noise sources.

### SUMMARY OF THE INVENTION

The present invention provides a structure, comprising a first hollow and helical pipe; a second hollow and helical pipe; a first transmission wire; a second transmission wire; and a dielectric connector physically coupled to the first hollow and helical pipe and the second hollow and helical pipe, wherein the first hollow and helical pipe and the second hollow and helical pipe comprise an electrically conductive material, wherein the first transmission wire comprises a first portion and a second portion, wherein the second transmission wire comprises a third portion and a fourth portion, and wherein the first portion of the first transmission wire and the third portion of the second transmission wire are inside the first hollow and helical pipe.

The present invention provides an antenna that is balanced and shorter than that of the prior art.

### BRIEF DESCRIPTION OF THE DRAWINGS

FIG. 1 shows a side-view of a dipole antenna and a signal source electrically coupled to the dipole antenna, in accordance with embodiments of the present invention.

FIG. 2 shows a side-view of a folded dipole antenna and a signal source electrically coupled to the folded dipole antenna, in accordance with embodiments of the present invention.

### DETAILED DESCRIPTION OF THE INVENTION

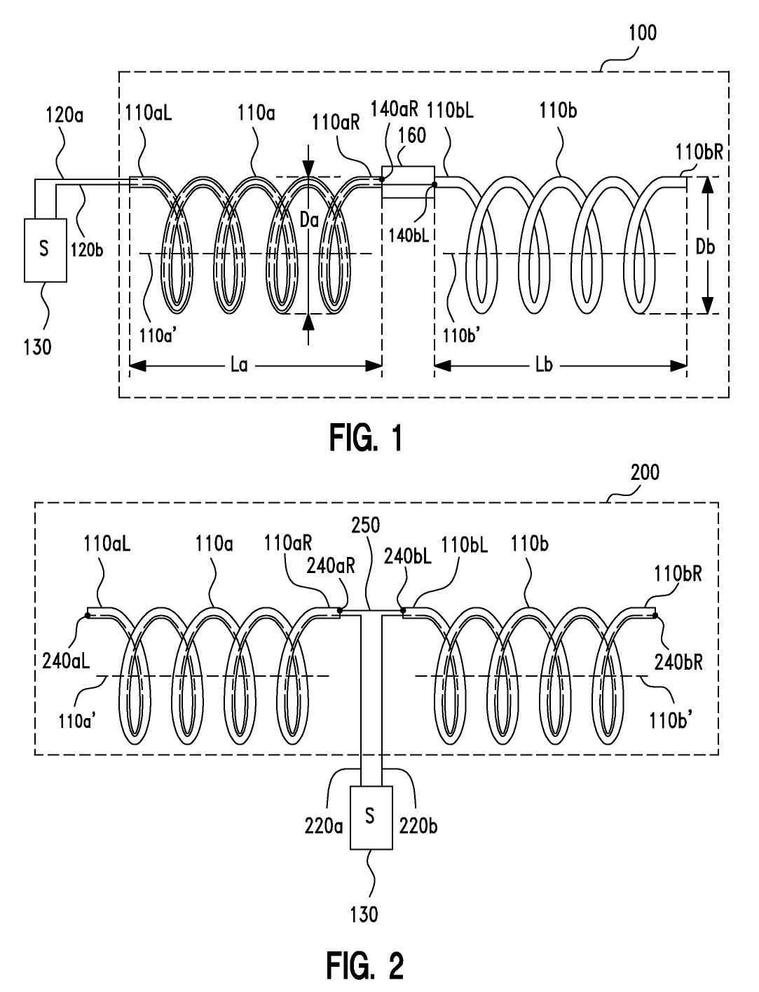

FIG. 1 shows a side-view of a dipole antenna 100 and a signal source 130 electrically coupled to the dipole antenna 100, in accordance with embodiments of the present invention. More specifically, with reference to FIG. 1, the dipole antenna 100 comprises hollow helix radiating elements 110a and 110b and transmission wires 120a and 120b. The hollow helix radiating elements 110a and 110b can be hollow and helical pipes. The hollow helix radiating elements 110a and 110b can be formed by winding two straight hollow pipes into helical shape. Alternatively, it can be formed by a coaxial cable manufactured with two center conductors. In one embodiment, the helical axis 110a′ of the hollow helix radiating element 10a and the helical axis 110b′ of the hollow helix radiating element 10b are on the same straight line.

Each of the hollow helix radiating elements 110a and 110b can be right-handed or left-handed. With the line of sight being helical axis, if clockwise movement of the helix corresponds to axial movement away from the observer, then it is a right-handed helix. If counter-clockwise movement corresponds to axial movement away from the observer, then it is a left-handed helix. It should be noted that the hollow helix radiating elements 110a and 110b shown in FIG. 1 are left-handed. If both the hollow helix radiating elements 110a and 110b are left-handed or if both the hollow helix radiating elements 110a and 110b are right-handed, it is said that the hollow helix radiating elements 110a and 110b are wound in the same direction. In an alternative embodiment, one of the hollow helix radiating elements 110a and 110b is left-handed whereas the other is right-handed.

In one embodiment, the hollow helix radiating element 110a comprises a left end 110aL and a right end 110aR. The hollow helix radiating element 110b comprises a left end 110bL and a right end 110bR. The hollow helix radiating elements 110a and 110b can comprise an electrically conductive material. In one embodiment, the hollow helix radiating elements 110a and 110b are electrically insulated from each other. A dielectric connector 160 can be used to physically couple the hollow helix radiating elements 110a and 110b together so as to keep the hollow helix radiating elements 110a and 1110b in place.

Let La and Lb represent axial lengths of the hollow helix radiating elements 110a and 110b, respectively. Let Da and Db represent diameters of the hollow helix radiating elements 110a and 110b, respectively. Let Lta and Ltb (not shown) represent the physical lengths of the hollow helix radiating elements 110a and 110b, respectively. The physical length of the hollow helix radiating element 110a is a length measured from the left end 110aL to the right end 110aR along the solid body of the hollow helix radiating element 110a. Similarly, the physical length of the hollow helix radiating element 110b is a length measured from the left end 110bL to the right end 110bR along the solid body of the hollow helix radiating element 110b. This is shorter than the physical length, while still being balanced. In one embodiment, Lta=Ltb=λ/4 (allowing plus and minus 10% tolerance), wherein λ is the wavelength of the signal generated by the signal source 130. In other words, the dipole antenna 100 is essentially a half-wave dipole antenna. For example, at a signal frequency of 46 MHz (λ˜6.2 m), Lta=Ltb=1.550 m. With plus and minus 10% tolerance, each of Lta and Ltb can be in the range of 1.395 m to 1.705 m. The physical lengths (i.e., La and Lb) can be shorter.

In one embodiment, the transmission wires 120a and 120b are electrically conductive wires. A portion of the transmission wire 120a and a portion of the transmission wire 120b are inside the hollow helix radiating element 110a and electrically insulated from each other. In one embodiment, the transmission wires 120a and 120b are shielded (covered) by a dielectric material such that the transmission wires 120a and 120b are electrically insulated from each other and electrically insulated from the hollow helix radiating element 110a.

In one embodiment, one end of the transmission wire 120a is electrically connected to the signal source 130, whereas the other end of the transmission wire 120a is electrically connected to the right end 110aR of the hollow helix radiating element 110a. The connection point 140aR represents electrical connection of the transmission wire 120a and the right end 110aR. In one embodiment, the transmission wire 120a is electrically connected to the hollow helix radiating element 110a via an electric path that goes through the right end 110aR such that there is no electric path between the transmission wire 120a and the hollow helix radiating element 110a that does not go through the right end 110aR. It should be noted that the transmission wire 120a is not electrically connected to the hollow helix radiating element 110b.

In one embodiment, one end of the transmission wire 120b is electrically connected to the signal source 130, whereas the other end of the transmission wire 120b is electrically connected to the left end 110bL of the hollow helix radiating element 110b. The connection point 140bL represents electrical connection of the transmission wire 120b and the left end 110bL. In one embodiment, the transmission wire 120b is electrically connected to the hollow helix radiating element 110b via an electric path that goes through the left end 110bL such that there is no electric path between the transmission wire 120b and the hollow helix radiating element 110b that does not go through the left end 110bL. It should be noted that the transmission wire 120b is not electrically connected to the hollow helix radiating element 110a. The dipole antenna 100 receives signal from the signal source 130 via the transmission wires 120a and 120b and radiates the received signal to the surrounding space using the hollow helix radiating elements 110a and 110b.

In one embodiment, two IBM TwinAx™ cable segments can be used to create the hollow helix radiating elements 110a and 110b and the transmission wires 120a and 120b. More specifically, the first IBM TwinAx™ cable segment is used as the hollow helix radiating element 10a and the transmission wires 120a and 120b. The second IBM TwinAx™ cable is used as the hollow helix radiating element 110b, wherein the two transmission wires of the second IBM TwinAx™ cable segment are not used (i.e., not electrically connected to anything).

It should be noted that the hollow helix radiating elements 110a and 110b are in shape of helix. Therefore, the axial lengths La and Lb of the hollow helix radiating elements 110a and 110b, respectively, are much shorter than their physical lengths Lta and Ltb. In the example above in which the physical lengths Lta and Ltb are equal to 1.55 m, the axial lengths La and Lb can be a few centimeters.

In one embodiment, the electromagnetic fields generated by transmitted signals on the portions of the transmission wires 120a and 120b inside the hollow helix radiating element 110a exists only in the space within the hollow helix radiating element 110a. As a result, the electromagnetic fields generated by transmitted signals on the portions of the transmission wires 120a and 120b inside the hollow helix radiating element 110a does not affect the radio wave generated by the hollow helix radiating elements 110a and 110b, as well as the radio wave transmitted to the hollow helix radiating elements 110a and 110b via the surrounding space (if any).

In one embodiment, the portions of the transmission wires 120a and 120b outside the hollow helix radiating element 110a are arranged in proximity such that the electromagnetic fields generated by transmitted signals on these portions essentially cancel each other out.

It should be noted that the current flowing into the hollow helix radiating element 110a is equal to the current flowing into the hollow helix radiating element 110b.

It should be noted that, with reference to FIG. 1, the dipole antenna 100 is an end-fed antenna. More specifically, the signal generated by the signal source 130 is fed at one end (the left end 110aL) of the dipole antenna 100. It should be noted that the dipole antenna 100 has two ends: the left end 110aL and the right end 110bR. The dipole antenna 100 can be used for operation in HF (high frequency) bandwidth, VHF (very high frequency) bandwidth, and UHF (ultra-high frequency) bandwidth.

In summary, with the two transmission wires 120a and 120b running inside the hollow helix radiating element 110a, the dipole antenna 100 is end-fed, balanced, and shortened (La and Lb are much shorter than Lta and Ltb).

FIG. 2 shows a side-view of a folded dipole antenna 200 and the signal source 130 electrically coupled to the folded dipole antenna 200, in accordance with embodiments of the present invention. More specifically, with reference to FIG. 2, the folded dipole antenna 200 comprises the hollow helix radiating elements 110a and 110b, transmission wires 220a and 220b, and a connection wire 250. In one embodiment, the helical axis 110a′ of the hollow helix radiating element 110a and the helical axis 110b′ of the hollow helix radiating element 110b are on the same straight line. In one embodiment, the hollow helix radiating elements 110a and 110b are electrically connected to each other via an electric path that goes through the right end 110aR and the left end 110bL such that there is no electric path between the hollow helix radiating elements 110a and 110b that does not go through right end 110aR and the left end 110bL. More specifically, the hollow helix radiating elements 110a and 110b are electrically connected to each other via only the connection wire 250 at connection points 240aR and 240bL, as shown in FIG. 2.

In one embodiment, the transmission wires 220a and 220b are electrically conductive wires. A portion of the transmission wire 220a is inside the hollow helix radiating element 110a, whereas a portion of the transmission wire 220b is inside the hollow helix radiating element 110b. In one embodiment, the transmission wires 220a and 220b are shielded (covered) by a dielectric material such that the transmission wires 220a and 220b are electrically insulated from the hollow helix radiating elements 110a and 110b, respectively, and such that the transmission wires 220a and 220b are electrically insulated from each other. The advantage of FIG. 2 is that the antenna picks up less electrical noise, and is effectively shielded from non-resonant interference.

In one embodiment, one end of the transmission wire 220a is electrically connected to the signal source 130, whereas the other end of the transmission wire 220a is electrically connected to the left end 110aL of the hollow helix radiating element 110a at the connection point 240aL. The connection point 240aL represents electrical connection of the transmission wire 220a and the left end 110aL. In one embodiment, the transmission wire 220a is electrically connected to the hollow helix radiating element 110a via an electric path that goes through the left end 110aL such that there is no electric path between the transmission wire 220a and the hollow helix radiating element 110a that does not go through the left end 110aL.

Similarly, one end of the transmission wire 220b is electrically connected to the signal source 130, whereas the other end of the transmission wire 220b is electrically connected to the right end 110bR of the hollow helix radiating element 110b at the connection point 240bR. The connection point 240bR represents electrical connection of the transmission wire 220b and the right end 110bR. In one embodiment, the transmission wire 220b is electrically connected to the hollow helix radiating element 110b via an electric path that goes through the right end 110bR such that there is no electric path between the transmission wire 220b and the hollow helix radiating element 110b that does not go through the right end 110bR. The folded dipole antenna 200 receives signal from the signal source 130 via the transmission wires 220a and 220b and radiates the received signal to the surrounding space using the hollow helix radiating elements 110a and 110b.

In one embodiment, two IBM TwinAx™ cable segments are used to create the hollow helix radiating elements 110a and 110b and the transmission wires 120a and 120b of FIG. 2. More specifically, the first IBM TwinAx™ cable segment is used as the hollow helix radiating element 110a and the transmission wire 220a. The other transmission wire of the first IBM TwinAx™ cable segment is not used (i.e., not electrically connected to anything). The second IBM TwinAx™ cable is used as the hollow helix radiating element 110b and the transmission wire 220b. The other transmission wire of the second IBM TwinAx™ cable segment is not used (i.e., not electrically connected to anything). Alternatively, each of the hollow helix radiating elements 110a and 110b of FIG. 2 can be formed using a regular coax cable with one center conductor or can be formed by winding a hollow tube with an inner conductor into a helix.

It should be noted that the hollow helix radiating elements 110a and 110b are in shape of helix. Therefore, the axial lengths La and Lb of the hollow helix radiating elements 110a and 110b, respectively, are much shorter than their physical lengths Lta and Ltb. In the example above in which the physical lengths Lta and Ltb are equal to 1.55 m, the axial lengths La and Lb can be a few centimeters.

It should be noted that the electromagnetic fields generated by transmitted signals on the portions of the transmission wires 220a and 220b inside the hollow helix radiating elements 110a and 110b exists only in the space within the hollow helix radiating elements 110a and 110b. As a result, the electromagnetic fields generated by transmitted signals on the portions of the transmission wires 220a and 220b inside the hollow helix radiating elements 110a and 110b does not affect the radio wave generated by the hollow helix radiating elements 110a and 110b, as well as the radio wave transmitted to the hollow helix radiating elements 110a and 110b via the surrounding space (if any).

In one embodiment, the portions of the transmission wires 220a and 220b outside the hollow helix radiating elements 110a and 110b, respectively, are arranged in proximity such that the electromagnetic fields generated by transmitted signals on these portions essentially cancel each other out.

It should be noted that the current flowing into the hollow helix radiating element 110a is equal to the current flowing into the hollow helix radiating element 110b, Therefore, the dipole antenna 110 is a balanced antenna.

It should be noted that, with reference to FIG. 2, the folded dipole antenna 200 is a center-fed antenna. More specifically, the signal generated by the signal source 130 is fed at exact center of the folded dipole antenna 100. The folded dipole antenna 200 can be used for operation in HF (high frequency) bandwidth, VHF (very high frequency) bandwidth, and UHF (ultra-high frequency) bandwidth.

In the embodiments described above, the hollow helix radiating elements 110a and 110b are electrically connected to each other by the connection wire 250. In an alternative embodiment, the hollow helix radiating elements 110a and 110b are bonded together such that the connection points 240aR and 240bL are in direct physical contact with each other. In other words, the right end 110bL of the hollow helix radiating element 110a and the left end 110bL of the hollow helix radiating element 110b are in direct physical contact with each other.

In summary, with the two transmission wires 220a and 220b running inside the hollow helix radiating elements 110a and 110b, respectively, the folded dipole antenna 200 is end-fed, balanced, and shortened (La and Lb are much shorter than Lta and Ltb).

In the embodiments described above, the dipole antenna 100 of FIG. 1 and the folded dipole antenna 200 of FIG. 2 receive signals from the signal source 130. Alternatively, the dipole antenna 100 and the folded dipole antenna 200 are used to receive signals from the surrounding space.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A structure, comprising:
a first hollow and helical pipe;
a second hollow and helical pipe;
a first transmission wire;
a second transmission wire; and
a dielectric connector physically coupled to the first hollow and helical pipe and the second hollow and helical pipe,
wherein the first hollow and helical pipe and the second hollow and helical pipe comprise an electrically conductive material,
wherein the first transmission wire comprises a first portion and a second portion,
wherein the second transmission wire comprises a third portion and a fourth portion, and
wherein the first portion of the first transmission wire and the third portion of the second transmission wire are inside the first hollow and helical pipe.

2. The structure of claim 1,
wherein the first hollow and helical pipe comprises a first end and a second end,
wherein the second hollow and helical pipe comprises a third end and a fourth end,
wherein the first transmission wire is electrically coupled to the first hollow and helical pipe via a first electric path that goes through the second end of the first hollow and helical pipe, and
wherein the second transmission wire is electrically coupled to the second hollow and helical pipe via a second electric path that goes through the third end of the second hollow and helical pipe.

3. The structure of claim 2,
wherein there is no electric path between the first transmission wire and the first hollow and helical pipe that does not go through the second end, and
wherein there is no electric path between the second transmission wire and the second hollow and helical pipe that does not go through the third end.

4. The structure of claim 2,
wherein the dielectric connector is in direct physical contact with the second end of the first hollow and helical pipe, and
wherein the dielectric connector is in direct physical contact with the third end of the second hollow and helical pipe.

5. The structure of claim 1,
wherein the first hollow and helical pipe is left-handed, and
wherein the second hollow and helical pipe is right-handed.

6. The structure of claim 1, wherein a first helical axis of the first hollow and helical pipe and a second helical axis of the second hollow and helical pipe are on a same straight line.

7. The structure of claim 1, further comprising a signal source,
wherein the signal source is electrically coupled to the first and second transmission wires, and
wherein the first hollow and helical pipe, the first portion of the first transmission wire, and the third portion of the second transmission wire are parts of an IBM TwinAx™ cable segment.

8. The structure of claim 7, wherein a sum of a first physical length of the first hollow and helical pipe and a second physical length of the second hollow and helical pipe is essentially equal to a half of a wavelength of a signal which the signal source is configured to generate.

9. The structure of claim 8, wherein the first physical length is essentially equal to the second physical length.

10. The structure of claim 1, wherein the second portion of the first transmission wire and the fourth portion of the second transmission wire are arranged in proximity such that electromagnetic fields generated by signals transmitted on the second and fourth portions essentially cancel each other out.

11. A structure, comprising:
a first hollow and helical pipe;
a second hollow and helical pipe;
a first transmission wire; and
a second transmission wire,
wherein the first hollow and helical pipe and the second hollow and helical pipe comprise an electrically conductive material,
wherein the first transmission wire comprises a first portion and a second portion,
wherein the second transmission wire comprises a third portion and a fourth portion,
wherein the first hollow and helical pipe comprises a first end and a second end,
wherein the second hollow and helical pipe comprises a third end and a fourth end,
wherein the first portion of the first transmission wire is inside the first hollow and helical pipe,
wherein the third portion of the second transmission wire is inside the second hollow and helical pipe,
wherein the first hollow and helical pipe is electrically coupled to the second hollow and helical pipe via a connecting electric path,
wherein the second end of the first hollow and helical pipe is on the connecting electric path, and
wherein the third end of the second hollow and helical pipe is on the connecting electric path.

12. The structure of claim 11, wherein there is no electric path between the first hollow and helical pipe and the second hollow and helical pipe that does not go through both the second end and the third end.

13. The structure of claim 11,
wherein the first transmission wire is electrically coupled to the first hollow and helical pipe via a first electric path that goes through the first end of the first hollow and helical pipe,
wherein the second transmission wire is electrically coupled to the second hollow and helical pipe via a second electric path that goes through the fourth end of the second hollow and helical pipe,
wherein there is no electric path between the first transmission wire and the first hollow and helical pipe that does not go through the first end of the first hollow and helical pipe, and
wherein there is no electric path between the second transmission wire and the second hollow and helical pipe that does not go through the fourth end of the second hollow and helical pipe.

14. The structure of claim 11, further comprising a signal source,
wherein the signal source is electrically coupled to the first and second transmission wires,
wherein a sum of a first physical length of the first hollow and helical pipe and a second physical length of the second hollow and helical pipe is essentially equal to a half of a wavelength of a signal which the signal source is configured to generate, and
wherein the first physical length is essentially equal to the second physical length.

15. The structure of claim 11,
wherein the second portion of the first transmission wire and the fourth portion of the second transmission wire are arranged in proximity such that electromagnetic fields generated by signals transmitted on the second and fourth portions essentially cancel each other out,
wherein the first hollow and helical pipe and the second hollow and helical pipe are wound in a same direction,
wherein the first hollow and helical pipe and the first portion of the first transmission wire are parts of a first regular coaxle cable, and
wherein the second hollow and helical pipe and the third portion of the second transmission wire are parts of a second regular coaxle cable.

16. The structure of claim 11, wherein the second end of the first hollow and helical pipe is in direct physical contact with the third end of the second hollow and helical pipe.

17. A structure formation method, comprising:
providing a first hollow and helical pipe, a second hollow and helical pipe, a first transmission wire, a second transmission wire, and a dielectric connector,
wherein the first hollow and helical pipe and the second hollow and helical pipe comprise an electrically conductive material;
using the dielectric connector to physically couple the first hollow and helical pipe to the second hollow and helical pipe; and
placing a first portion of the first transmission wire and a third portion of the second transmission wire inside the first hollow and helical pipe.

18. The method of claim 17, further comprising:
electrically coupling the first transmission wire to the first hollow and helical pipe via a first electric path that goes through a second end of the first hollow and helical pipe; and
electrically coupling the second transmission wire to the second hollow and helical pipe via a second electric path that goes through a third end of the second hollow and helical pipe,
wherein there is no electric path between the first transmission wire and the first hollow and helical pipe that does not go through the second end, and
wherein there is no electric path between the second transmission wire and the second hollow and helical pipe that does not go through the third end.

19. The method of claim 17, further comprising electrically coupling a signal source to the first and second transmission wires,
wherein a sum of a first physical length of the first hollow and helical pipe and a second physical length of the second hollow and helical pipe is essentially equal to a half of a wavelength of a signal which the signal source is configured to generate, and
wherein the first physical length is essentially equal to the second physical length.

20. The method of claim 17, further comprising placing a second portion of the first transmission wire and a fourth portion of the second transmission wire in proximity such that electromagnetic fields generated by signals transmitted on the second and fourth portions essentially cancel each other out.
